(19) United States
(12) Patent Application Publication
(10) Pub. No.: US 2006/0149958 A1
(43) Pub. Date: Jul. 6, 2006

(54) Code download in a system having multiple integrated circuits with a jtag capability

(76) Inventor: Padraig Omathuna, SAN JOSE, CA (US)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/538,456

(22) PCT Filed: Dec. 17, 2003
(86) PCT No.: PCT/IB03/06048

§ 371 Date: Jun. 10, 2005

Related U.S. Application Data
(60) Provisional application No. 60/434,822, filed on Dec. 18, 2002.

(51) Int. Cl. G06F 9/24

(52) U.S. Cl. 713/2

(57) ABSTRACT

An electronic product (500) including a first integrated circuit (502) coupled to a first memory (506) and at least a second integrated circuit (508, 512) coupled (516, 518, 520) to the first integrated circuit. The first integrated circuit loads information, such as a first code image, from the first memory into the first integrated circuit, and executes at least a portion of the first code image. In response to such code execution, the first integrated circuit reads information, such as a second code image, from the first memory and transmits that information to the second integrated circuit. The interface between the first and second integrated circuits for transmission of the information may be a test circuitry (522, 528, 526, 524) interface such as JTAG circuitry. In one embodiment program code is transferred from a single external memory through a first integrated circuit to one or more downstream integrated circuits by way of serially connected JTAG data and control pins.

The present invention relates generally to electronic systems, and more particularly relates to methods and apparatus for efficiently loading information into a plurality of integrated circuits, each of which requires such information to perform its intended function.

Advances in semiconductor manufacturing technology, as well as in digital systems architecture, have resulted in the ability to design and produce larger integrated circuits incorporating much more functionality than has been possible in the past. A particular class of integrated circuits, which incorporate at least several large functional blocks to produce a high level of functionality, is referred to as System on Chip (SoC). Such SoC integrated circuits often include one or more processors along with memory for storing program code that is to be executed by the processors, and one or more circuit blocks for implementing various high-level peripheral functions.

The SoC is typically used in an electronic product, or system, that includes various other components. In a typical arrangement, a SoC and a non-volatile memory, such as a ROM or flash, which is external to the SoC, are mounted on a substrate, such as a printed circuit board. In this case, the external non-volatile memory is coupled to the SoC so as to provide program code that is loaded into the SoC for subsequent use by the one or more processors integrated thereon. In other arrangements, memory for program code may be completely or partly external to the SoC. As electronic products become more complex, a need has arisen to include multiple SoCs in a single electronic product.

What is needed are methods and apparatus for, efficiently loading information into a plurality of integrated circuits, such as SoCs, that are included in an electronic product.

Briefly, embodiments of the present invention provide for loading information from a single non-volatile external memory, into a plurality of integrated circuits, wherein only one of the plurality of integrated circuits is connected for memory access to the single non-volatile external memory.

In a further aspect of the present invention, the information loaded into at least one of the plurality of integrated circuits comprises program code that can be executed by a processor included within the at least one integrated circuit.

In a still further aspect of the present invention, the communication path used for transferring program code from a single external memory through a first integrated circuit to a second integrated circuit is comprised of the test pathways within each of the first and second integrated circuits.

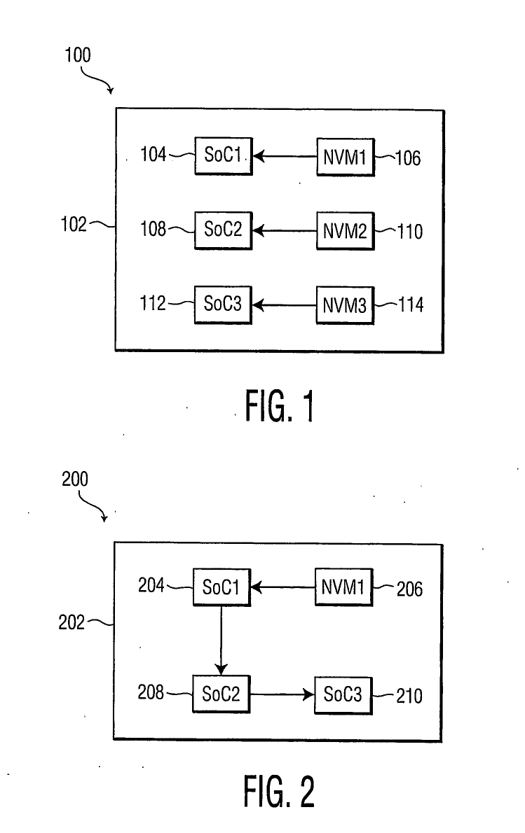

FIG. 1 is a schematic block diagram of a conventional electronic product including a plurality of SoCs, each SoC coupled to a separate external non-volatile memory chip from which program code is transferred to the SoC.

FIG. 2 is a high level block diagram of an electronic product in which a single external memory chip supplies information, such as program code to a plurality of SoCs, in accordance with the present invention.

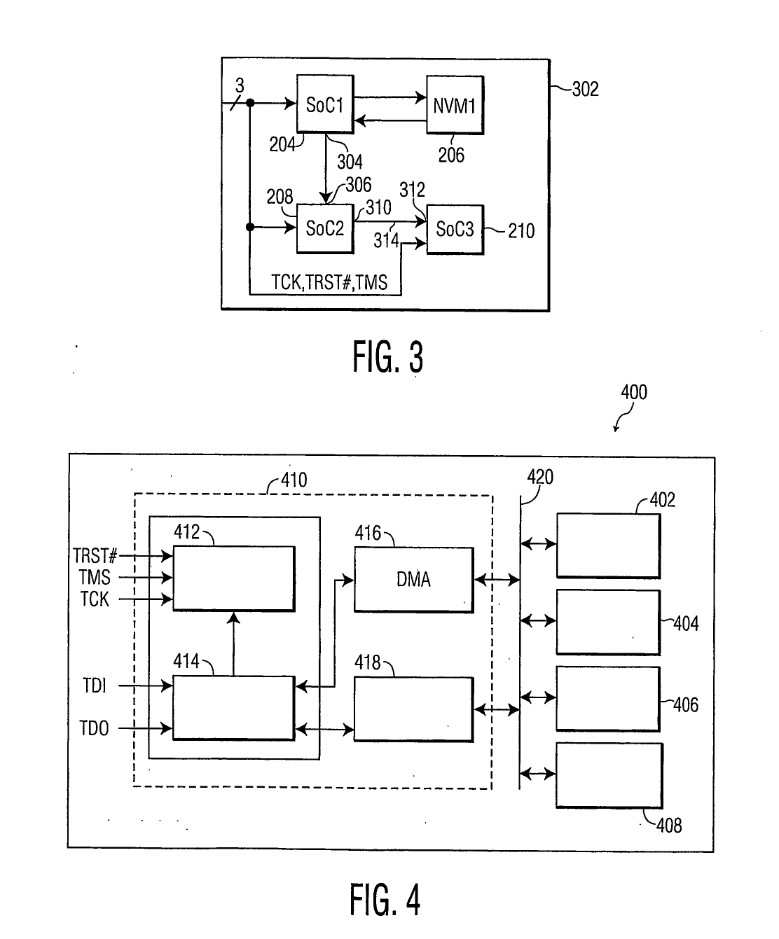

FIG. 3 is a schematic block diagram of an electronic product in which a single external memory chip supplies information, such as program code to a plurality of SoCs through a JTAG mechanism, in accordance with the present invention.

FIG. 4 is a schematic block diagram of an integrated circuit, suitable for use in an embodiment of the present invention, generally showing a JTAG compliant integrated circuit, and more particularly illustrating EJTAG extensions.

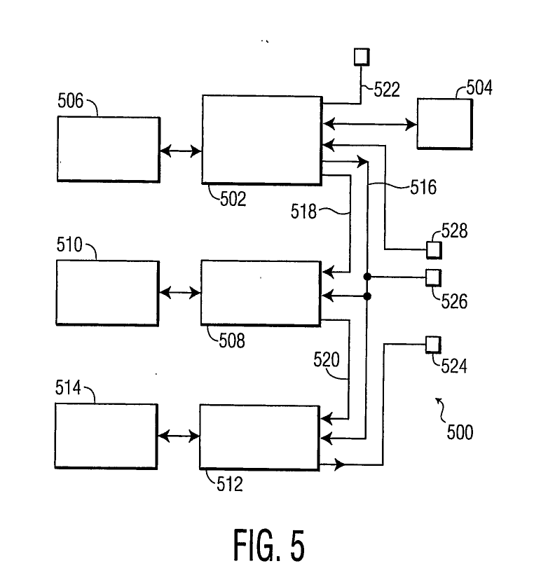

FIG. 5 is a schematic block diagram of an electronic product in which a single external non-volatile memory chip supplies information, such as program code to a plurality of SoCs, each SoC also having a private external memory, through a JTAG mechanism, in accordance with the present invention.

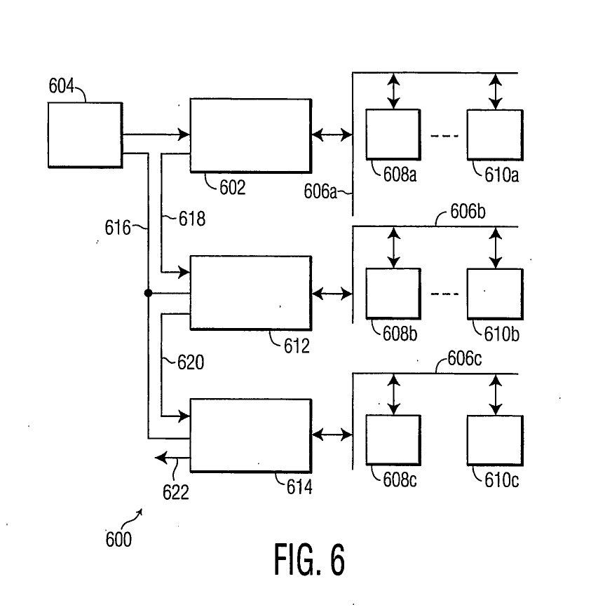

FIG. 6 is a schematic block diagram of an electronic product in which a single non-volatile external memory chip supplies information, such as program code to a plurality of SoCs, through a JTAG mechanism, in accordance with the present invention, and each SoC is coupled to its own external memory bus.

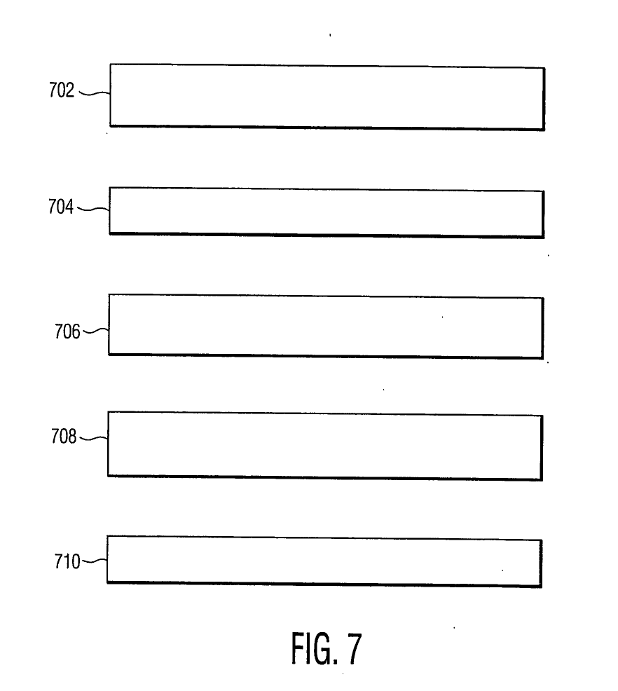

FIG. 7 is a flowchart of an illustrative process in accordance with the present invention.

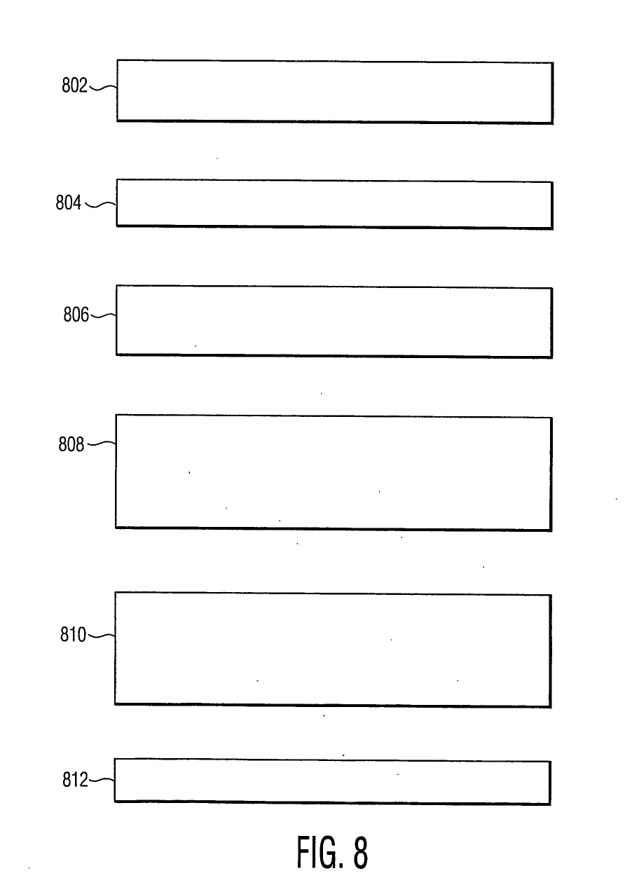

FIG. 8 is a flowchart of another illustrative process in accordance with the present invention.

Electronic products that include multiple integrated circuits, where those integrated circuits are themselves of the “Systems on a Chip” (SoC) variety, are becoming more and more prevalent due to time-to-market constraints. That is, a system solution that provides a certain functionality may now be realized more quickly by integrating several SoCs at the board level, rather than by producing a new ASIC (i.e., SoC) with the combined functionality of those multiple SoCs. Conventionally, each of such SoCs includes, among other things, a processor for executing program code, and a memory for storing the program code to be executed by that processor. In some conventional alternative arrangements, an external memory for storing the program code to be executed by the processor, is coupled to the SoC. Also conventionally, each one of such SoCs must be coupled to a separate external memory from which program code is loaded into the SoC. In this conventional arrangement, each SoC is coupled to a separate memory, which adds considerably to the cost of the electronic product.

Various embodiments of the present invention provide the program code, from a single external memory, for each of the multiple SoCs in the system, by using an existing communication interface on each of the SoCs that is normally used for system debugging operations. In some embodiments, the JTAG circuitry included in each of the SoCs is used to provide the communication interface used for downloading code.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

The acronym ASIC refers to an Application Specific Integrated Circuit.

The acronym JTAG refers to the Joint Test Action Group. The Institute of Electrical and Electronic Engineers (IEEE) has approved IEEE Standard 1149.1, Test Access Port and Boundary Scan Architecture.

The acronym LSI refers to Large Scale Integration.

The acronym NVM refers to non-volatile memory, and includes any suitable data storage means that retains data without power being applied. Examples of non-volatile memories include, but are not limited to, ROM, PROM, EPROM, and flash.

The acronym SoC refers to a System on a Chip, with SoCs being the plural of SoC.

The acronym TAP refers to a Test Access Port.

MIPS EJTAG refers to a hardware debug facility that provides non-intrusive debug capabilities for SoCs that include embedded MIPS architecture processors. A similar, but alternative arrangement, referred to as ICE, is available for the ARM processor architecture.

The terms chip, semiconductor device, integrated circuit, LSI device, monolithic integrated circuit, ASIC, SoC, microelectronic device, and similar expressions are sometimes used interchangeably in this field. Microelectronic device may be considered to be the broadest term, encompassing the others. With respect to these microelectronic devices, signals are coupled between them and other circuit elements via physical, electrically conductive connections. The point of connection is sometimes referred to as an input, output, terminal, line, pin, pad, port, interface, or similar variants and combinations. These are considered equivalent terms for the purpose of this disclosure.

The term downloading is used herein to refer to the transfer of information, including, but not limited to, program code, from an external memory to an integrated circuit, such as for example an SoC, that is either directly connected, or indirectly coupled, to the external memory.

Programming instructions are sometimes referred to as code. It is often necessary to provide data, such as, for example, constants, along with programming instructions to construct a working program. Similar expressions include, but are not limited to, program code, software, firmware, and microcode.

A JTAG compliant device includes pins for clock, input data, output data, and mode selection, referred to, respectively, as TCK, TDI, TDO, and TMS. TCK refers to Test Clock Input which is a terminal of the JTAG compliant device that receives a clock signal separate from the system clock. TDI refers to a Test Data In which is a terminal through which data is shifted into the JTAG compliant device. TDO refers to Test Data Out which is a terminal through which data is shifted out of the JTAG compliant device. TMS refers to Test Mode Select which is a terminal which receives data for determining which of one or more test modes the in which the JTAG compliant device is to operate. A JTAG compliant device may be any type of integrated circuit such as, for example, a microprocessor, an ASIC, or a SoC. A JTAG compliant device may also include a pin to receive a low active reset signal, referred to as TRST#. JTAG compliant devices include a boundary scan register and a TAP controller. The TAP controller is a state machine that controls the JTAG functions. The boundary scan register is made up of a number of serially connected bits where each of those bits is also coupled to digital pins of the JTAG compliant device. JTAG compliant devices may also include other registers, such as, a data register, an instruction register, and a bypass register.

A SoC with EJTAG uses the 5-pin JTAG interface, which is specified in the IEEE 1149.1 JTAG standard, for communication with other components. The EJTAG circuitry also provides a means of directly controlling the behavior of the embedded processor. Internally, the SoC with EJTAG includes circuitry for, among other things, accessing the address and data busses which are typically used by the embedded processor, program memory, and other functional blocks included within the SoC.

Various embodiments of the present invention use the existing debug capabilities of a SoC in a production environment to reduce the overall cost of a complete system that includes two or more SoCs. Conventionally, each SoC has a counterpart external memory from which it boots up. Some embodiments of the present invention store the code images for each SoC of a multi-SoC electronic product, in a single external memory which is interfaced to a single one of the SoCs. The code image for each of the downstream SoCs is transferred thereto via an interface between the SoC that is interfaced to the external memory and each of the downstream SoCs.

Referring to FIG. 1, a conventional electronic product 100 is shown. Conventional electronic product 100 includes a printed circuit board 102, having first, second, and third SoCs 104, 108, 112, and first, second, and third non-volatile memories 106, 110, 114 disposed thereon. SoCs 104, 108, 112 are typically integrated circuits having at least the circuitry necessary for providing a processor for executing programming instructions, and a memory for storing programming instructions. Non-volatile memories 106, 110, 114 are coupled, respectively, to first, second, and third SoCs 104, 108, 112 such that code may be transferred between each respectively coupled SoC and non-volatile memory. It can be seen that in the conventional approach of FIG. 1, each SoC requires a separate non-volatile memory and a pathway to access those separate non-volatile memories. These components, as well as, the space and power they require, increase the manufacturing and operating costs of an electronic product constructed in this way.

Referring to FIG. 2, an electronic product 200 in accordance with the present invention is shown. Electronic product 200 includes a substrate 202. Substrate 202 is typically a printed circuit board, but may be any suitable material or construction for supporting integrated circuits, or other components, which may be disposed thereon. As shown in FIG. 2, a first non-volatile memory 206, a first SoC 204, a second SoC 208, and a third SoC 210 are disposed on substrate 202. SoCs 204, 208, 210, may have the same hardware facilities or different hardware facilities, although in typical embodiments, these have different hardware facilities for implementing different functions. By way of example and not limitation, a first SoC may include hardware facilities for implementing a cable modem interface, while a second SoC may include hardware facilities for implementing an MPEG decoder. In this illustrative example, SoCs 204, 208, 210, each include a MIPS architecture processor and EJTAG debug facilities. It will be appreciated by those of ordinary skill in the art having the benefit of this disclosure that other debug facilities may be used as long as access to the embedded memory of the SoC is provided.

First non-volatile memory 206 and first SoC 204 are connected such that SoC 204 can access, i.e., read, the contents of first non-volatile memory 206. Another way of describing this is to say that first SoC 204 includes an external memory interface that is connected to the external memory (i.e., non-volatile memory 206). SoC 204 is coupled to SoC 208 to communicate data from SoC 204 to SoC 208. Similarly, SoC 208 is coupled to SoC 210 to communicate data from SoC 208 to SoC 210. Such a configuration permits data, such as, for example, code images, to be transferred from non-volatile memory 206 via an external memory interface to SoC 204, via the external memory interface and through SoC 204 to SoC 208, and via the external memory interface, through SoC 204, and through SoC 208 to SoC 210.

Referring to FIG. 3, an electronic product 300 in accordance with the present invention is shown. Electronic product 300 of FIG. 3 is similar to that shown in FIG. 2, but more particularly illustrates signal pathways for implementation with a JTAG interface for transferring code images from a single external memory to each of a plurality of integrated circuits wherein only one of the plurality of integrated circuits is coupled to read the external memory. A first non-volatile memory 206, a first SoC 204, a second SoC 208, and a third SoC 210 are disposed on a substrate 302. JTAG clock, reset, and mode select signals (TCLK, TRST#, and TMS) are coupled in common to each of first, second, and third SoCs 204, 208, 210. These signals are driven by first SoC 204 during the code download operation of the present invention, whereas these signal would conventionally be driven from outside signal sources for conventional uses of JTAG circuitry. First non-volatile memory 206 and first SoC 204 are connected such that SoC 204 can access, i.e., read, the contents of first non-volatile memory 206. SoC 204 is coupled to SoC 208 to communicate data from SoC 204 to SoC 208. More particularly, an output terminal 304 of SoC 204 is coupled to an input terminal 306 of SoC 208 by a conductive pathway 308. In this illustrative embodiment, output terminal 304 is a JTAG test data output (TDO) pin, and input terminal 306 is a JTAG test data input (TDI) pin. Similarly, SoC 208 is coupled to SoC 210 to communicate data from SoC 208 to SoC 210. More particularly, an output terminal 310 of SoC 208 is coupled to an input terminal 312 of SoC 210 by a conductive pathway 314. In this illustrative embodiment, output terminal 304 is a JTAG test data output (TDO) pin, and input terminal 306 is a JTAG test data input (TDI) pin. Such a configuration permits data, such as, for example, code images, to be transferred from non-volatile memory 206 via an external memory interface to SoC 204, via the external memory interface and through SoC 204 to SoC 208, and via the external memory interface, through SoC 204, and through SoC 208 to SoC 210. Circuitry internal to SoCs 208, 210 control the loading of the program code, for example, into their internal memories.

Still referring to the illustrative embodiment shown in FIG. 3, it is noted that there may optionally be a connection (not shown) between a test data output pin of SoC 210 and a test data input pin of SoC 204 to create a return path. Such a connection provides for situations in which SoC 204 is required to determine the status of the various downstream SoCs.

Referring to FIG. 4, a high-level schematic block diagram of a JTAG compliant IC, which includes EJTAG functionality, is shown. More particularly, a SoC 400, which includes a CPU 402, debug registers 404, system memory 406 for storing at least program code, a peripheral functional block 408, and an EJTAG block 410, is shown. EJTAG block 410 includes a TAP controller 412, instruction, data, control, and boundary scan registers 414, a direct memory access (DMA) module 416, and a processor access module 418. SoC 400 further includes address/data bus 420 to which are coupled CPU 402, debug registers 404, system memory 406, DMA module 416, and processor access module 418. It is noted that: in some embodiments the system memory may be located off-chip; the DMA module is not necessarily included in all embodiments; and that some embodiments may include direct control and/or status connections between the EJTAG circuitry and the processor. TAP controller 412 has input terminals for receiving JTAG clock, reset, mode select, and data input signals, and further has an output terminal for transmitting a data output signal. Such an arrangement provides a mechanism for transferring information into and out of the system memory.

Referring to FIG. 5, a schematic block diagram of an electronic product 500 that includes a single non-volatile memory and several SoCs, with each SoC having a connection to its own private external memory. In this illustrative embodiment, a SoC 502, capable of operating as an EJTAG Master device, is coupled to a non-volatile memory 504. SoC 502 additionally has an input terminal coupled to a node 522 from which it receives a JTAG Compliance Enable signal. The JTAG Compliance Enable signal is used in connection with changing the operational mode of SoC 502 between JTAG master and JTAG slave. NVM 504 may contain program code and/or other data to be loaded into a plurality of the SoCs in electronic product 500. An external memory 506 is coupled to SoC 502. External memory 506 is capable of storing, among other things, program code and/data which is downloaded from NVM 504. In a similar fashion, as illustrated in FIG. 5, SoCs 508, 512, are respectively coupled to their own private external memories 510, 514. SoCs 508, 512 are capable of operating as EJTAG Slave devices. Additionally, a communication pathway 516, for providing control signals from the EJTAG Master device to the EJTAG Slave device, is coupled between SoCs 502, 508, and 512 as shown. It is noted that these control signals (such as for example, clock, reset, and mode) may be driven by an external source, such as a tester from port 526 when electronic product 500 is suitably configured to operate in a test mode. Communication pathway 516 typically provides for communication of signals such as, for example, a clock signal, a reset signal, and a mode signal. Also shown in FIG. 5 is a pathway 518 for connecting a test data output terminal of SoC 502 to a test data input terminal of SoC 508; and a pathway 520 for connecting a test data output terminal of SoC 508 to a test data input terminal of SoC 512. It is noted that the test data output of SoC 512 may be observed at port 524, and that the test data input of SoC 502 may be driven from port 528. Furthermore, it is noted that, a return loop may be created connecting the test data output of SoC 512 to the test data input of SoC 502.

In operation, illustrative electronic product 500 may transfer information, such as program code and/or data from NVM 504 to private external memories 506, 510, and 512 under control of the EJTAG Master device which utilizes the JTAG serial data pathways included in SoCs 502, 508, and 512. It is noted that, in various embodiments, SoCs 502, 508, and 512 may each have some amount of memory incorporated within themselves, and in some embodiments these internal memories may also store program code and/or data.

Referring to FIG. 6, a schematic block diagram of an electronic product 600 that includes a single non-volatile memory and several SoCs, with each SoC having a connection to its own memory bus is shown. This exemplary embodiment illustrates an advantage of the present invention wherein non-volatile memory is removed from the memory bus thereby reducing bus loading and allowing for higher speed operation of the memory devices coupled to the memory bus. Another advantage of such an arrangement is that the memory controller logic of the SoCs is simplified because the SoCs only need to interface to RAM, rather than both RAM and NVM (which may have different control signal specifications for memory access). More particularly, a SoC 602 is coupled to a NVM 604, which is capable of operating as an EJTAG Master device. In this illustrative embodiment, NVM 604 is a flash memory that includes the circuitry to be an EJTAG Master device, even though it does not have a processor, or CPU, integrated therein. SoC 602, along with SoCs 612 and 614 are each respectively coupled to a memory bus 606a, 606b, 606c. Memory devices 608a, 610a; 608b, 610b; and, 608c, 610c, are shown coupled respectively to memory buses 606a, 606b, 606c. It is noted that there are a wide variety of commercially available memory architectures, and memory access protocols, however memory devices 608a, 610a; 608b, 610b; and, 608c, 610c may be any suitable memories such as, but not limited to, static random access memories or dynamic random access memories. It is further noted that although two memory devices are shown coupled to the memory bus, the present invention is not limited to any particular number of such devices.

Still referring to FIG. 6, communication path 616 is shown coupled between EJTAG Master NVM 604 and SoCs 602, 612, and 614. Communication path 616 is suitable for providing control signals such as, but not limited to, a clock signal, a reset signal, and a mode signal. A communication path 618 couples a test data output terminal of SoC 602 to a test data input terminal of SoC 612. A communication path 620 couples a test data output terminal of SoC 612 to a test data input terminal of SoC 614.

It is noted that the present invention may alternatively be embodied in a configuration similar to that shown in FIG. 6, with the exception that each SoC accesses volatile memory over a common memory bus rather than private memory buses.

Referring to FIG. 7, an illustrative process in accordance with the present invention is shown. In a first operation 702, a first program code is transferred from a first memory to a first integrated circuit. The first memory is typically a single chip, and is also typically a non-volatile memory chip, such as for example a Read-Only-Memory (ROM) or a flash. In accordance with the present invention, the first memory may also be implemented as multiple stacked memory chips that are addressable as a single package or unit. The first program code typically includes a plurality of instructions that are executable by a processor within the first integrated circuit. The first program code may also include data, i.e., non-executable information, that can be used by a processor on the first integrated circuit. The processor on the first integrated circuit may be of any suitable architecture. One example of a processor architecture that may be used in an SoC in accordance with the present invention is the MIPS architecture. However, the present invention is not limited to any particular processor architecture. The first integrated circuit may implement any arbitrary function; may be of a class of integrated circuits referred to as an SoC; and may be an SoC that includes JTAG test circuitry (e.g., boundary scan register, TAP controller, mode select register, bypass register, etc.). The first IC includes a memory in which program code may be stored (although as noted above, alternative embodiments have this memory external to the IC). The first integrated circuit typically includes a pathway, such as that provided by EJTAG circuitry, that allows information to be transferred into and out of the memory. The first program code is stored 704 in the first IC. As shown in FIG. 7, a second program code is transferred 706 from the first memory to the first IC, and the second program code is transmitted 708 from the first IC to a second IC that is coupled to the first IC. The second IC may implement any arbitrary function; may be of a class of integrated circuits referred to as an SoC; and may be an SoC that includes a JTAG test circuitry interface for communication. The second program code is stored 710 in the second IC. It is noted that one or more additional integrated circuits may receive code from the first memory by way of the first integrated circuit, and any intermediately coupled integrated circuits in accordance with the present invention. The transmission of the second program code from the first IC to the second IC may be accomplished by any suitable interface arrangement. In some embodiments of the present invention, the interface arrangement is that provided by the JTAG test circuitry included in the first and second integrated circuits. It is noted that the transfer of data may, but is not required to, take place in a pipelined fashion, that is a portion of the data to be transferred is moved and then the process is iterated until all the required data has been transferred.

Referring to FIG. 8, another illustrative process in accordance with the present invention is shown. In a first operation 802, a first program code is transferred from a first memory to a first IC. The first memory is typically a single-chip non-volatile memory IC. The first program code typically includes a plurality of instructions that are executable by a processor incorporated within the first IC. The first program code may also include data. The first IC may implement any arbitrary function; may be of a class of integrated circuits referred to as an SoC; and may be an SoC that includes JTAG test circuitry. The first IC includes a memory in which program code may be stored. The first program code is stored 804 in the first IC. The first IC then executes 806 at least a portion of the first program code. In response to the execution of at least a portion of the first program code in the first IC, a second program code is transferred 808 from the first memory to the first IC. In further response to the execution of at least a portion of the first program code, the second program code is transmitted 810 from the first IC to a second IC that is coupled to the first IC. The second IC may implement any arbitrary function; may be of a class of integrated circuits referred to as an SoC; and may be an SoC that includes JTAG test circuitry. In the illustrative embodiment of the present invention, the second program code is serially shifted out of the first IC via its JTAG data output pin, and serially shifted in to the second IC via the JTAG data input pin of the second IC. The second program code is stored 812 in the second IC such that it may be executed by a processor included within the second IC. It is noted that one or more additional integrated circuits may receive code from the first memory by way of the first IC, and any intermediately coupled integrated circuits in accordance with the present invention.

In one illustrative embodiment, a first IC loads program code from an external memory and then boots up into a state from which it can begin to download code into one or more downstream integrated circuits to which it is coupled (directly or indirectly). In such an embodiment the first IC may initialize a memory controller of a second IC, download code into the memory of the second IC, and set the embedded processor of the second IC running from the memory of the second IC. Similarly, the first IC may download code to, and start, each of a plurality of downstream ICs.

In an alternative illustrative embodiment, the first IC loads program code from an external memory but only boots up to a limited extent, rather than to its completely functional mode, before it begins the process of downloading code to downstream integrated circuits. After, one or more downstream devices have been loaded with program code, the first integrated circuit may return to its boot up operation. By initiating parallel operations, the total system boot up time may be reduced, since downstream devices have begun their respective boot up operations prior to the first IC completing its boot up operation.

In a further alternative embodiment, code may be downloaded into two or more downstream devices concurrently.

Although various illustrative embodiments of the present invention have been described in terms of electronic products having a plurality of integrated circuits that include processors, and the downloading of program code to those integrated circuits for execution by the processors, it is noted that the present invention is more widely applicable. For example, rather than program code suitable for execution, one or more of the ICs in an illustrative electronic product may receive data or control information. As noted above, the downstream integrated circuits that receive information from a single memory in accordance with the present invention interface with another IC disposed intermediate the memory and the IC receiving the information. Additionally, although a JTAG-based interface is described in illustrative embodiments of the present invention, any suitable interface may be used for the data transfer operations between the single external memory and the various integrated circuits included in the electronic product.

It is noted that the single external memory chip referred to in various illustrative embodiments of the present invention, may additionally have circuitry included thereon which implements any arbitrary functionality.

Various embodiments of the present invention combine existing hardware capabilities of a plurality of individual integrated circuits, such as for example JTAG-compliant SoCs, in a novel manner to provide systems and methods to reduce the size, cost, and power consumption, of electronic products.

In some embodiments, the JTAG debug capabilities of individual integrated circuits are combined in a production environment such that code images for each IC in a system can be stored in a single flash memory, attached to an EJTAG master enabled device, and downloaded into each target device once the EJTAG master device has booted up.

It is to be understood that the present invention is not limited to the embodiments described above, but encompasses any and all embodiments within the scope of the subjoined claims.

1. A method of transferring programming instructions from a first memory disposed on a substrate, to a plurality of integrated circuits (ICs) disposed on the substrate, comprising: a first one of the plurality of ICs accessing the first memory, retrieving a first set of programming instructions, and storing the first set of programming instructions within the first one of the plurality of ICs; and the first one of the plurality of ICs accessing the first memory integrated circuit, retrieving a second set of programming instructions, and transmitting the second set of programming instructions to a second one of the plurality of ICs.

2. The method of claim 1, wherein the first and second ones of the plurality of ICs each comprises a processor capable of executing, respectively, the first and second sets of programming instructions.

3. The method of claim 2, further comprising the first one of the plurality of ICs executing at least a portion of the first set of programming instructions.

4. The method of claim 3, wherein executing at least a portion of the first set of programming instructions occurs prior to transmitting the second set of programming instructions to a second one of the plurality of ICs.

5. The method of claim 2, further comprising the first one of the plurality of ICs accessing the first memory, retrieving a first set of data, and storing the first set of data within the first one of the plurality of ICs; and the first one of the plurality of ICs accessing the first memory, retrieving a second set of data, and transmitting the second set of data to a second one of the plurality of ICs.

6. The method of claim 3, wherein the substrate comprises a printed circuit board.

7. The method of claim 3, wherein transmitting comprises serially shifting data out from the first integrated circuit and concurrently shifting data in to the second integrated circuit.

8. The method of claim 7, further comprising transmitting control information from the first integrated circuit to the second integrated circuit prior to transmitting the second set of programming instructions to a second one of the plurality of ICs.

9. The method of claim 8, wherein the control information directs the second one of the plurality of ICs to receive a subsequent transmission of programming instructions.

10. In a system including a plurality of integrated circuits (ICs) disposed on a printed circuit board, each IC comprising a memory for storing at least programming instructions, each further comprising a processor coupled to the memory for executing programming instructions stored in the memory; the system further including a single non-volatile memory disposed on the printed circuit board and coupled for memory access to only a first one of the plurality of ICs, a method of downloading code from the single non-volatile memory to each of the plurality of ICs, comprising: receiving, at a first one of the plurality of ICs, a first set of data from the single non-volatile memory; storing the first set of data in the memory of the first one of the plurality of ICs; receiving, at the first one of the plurality of ICs, a second set of data from the single non-volatile memory; transmitting the second set of data from the first one of the plurality of ICs to the second one of the plurality of ICs; and storing the second set of data in the memory of the second one of the plurality of ICs; wherein the first and second sets of data comprise program code.

11. The method of claim 10, further comprising: executing, in the first IC, at least a portion of the program code in the first set of data; receiving, at the first one of the plurality of ICs, a third set of data from the single non-volatile memory; transmitting the third set of data from the first one of the plurality of ICs to a third one of the plurality of ICs; and storing the third set of data in the memory of the third one of the plurality of ICs;

12. The method of claim 10, wherein transmitting the second set of data from the first one of the plurality of ICs to the second one of the plurality of ICs comprises serially shifting data out of the first one of the plurality of ICs via an output terminal; wherein the output terminal is coupled to an input terminal of the second one of the plurality of ICs, the input terminal coupled to circuitry within the second one of the plurality of ICs that is adapted to receive serial data.

13. The method of claim 12, further comprising providing transmitting control information from the first one of the plurality of ICs to the second one of the plurality of ICs prior to transmitting the second set of data.

14. The method of claim 13, wherein control information is transmitted in accordance with a JTAG standard of communication.

15. An electronic product, comprising: a first integrated circuit having a first processor, a first internal memory, a first serial communication interface, and an external memory interface; an external memory coupled to the external memory interface; a second integrated circuit having second processor, a second internal memory, and a second serial communication interface, the second serial communication interface being coupled to the first serial communication interface; wherein the first integrated circuit, the external memory, and the second integrated circuit are disposed on a substrate.

16. The electronic product of claim 15, wherein the first processor is coupled to the first internal memory, the first internal memory is adapted to receive a first code image, the second processor is coupled to the second internal memory, the second internal memory is adapted to receive a second code image, and the external memory is a non-volatile memory encoded with the first and second code images.

17. The electronic product of claim 16, wherein the first integrated circuit includes a first hardware facility for performing at least a first function, and the second integrated circuit includes a second hardware facility for performing at least a second function, and the first and second functions are different.

18. The electronic product of claim 17, further comprising a third integrated circuit, having a third processor, a third internal memory, and a third serial communication interface, the third serial communication interface being coupled to the second serial communication interface, the third processor coupled to the third internal memory, the third internal memory is adapted to receive a third code image, and the external memory further encoded with the third code image.
